(19) United States
(12) Patent Application Publication
(10) Pub. No.: US 2022/0189236 A1
(43) Pub. Date: Jun. 16, 2022

(54) Product Storage Device of Automatic Vending Machine

(71) Applicant: SANDEN RETAIL SYSTEMS CORPORATION, Isesaki-shi (JP)

(72) Inventors: Dai TAKAHASHI, Isesaki-shi (JP); Masaru TSUNODA, Isesaki-shi (JP)

(21) Appl. No.: 17/440,065

(22) PCT Filed: Mar. 12, 2020
(86) PCT No.: PCT/JP2020/010736

§ 371 Date: Sep. 16, 2021

(30) Foreign Application Priority Data
Mar. 6, 2020 (JP) 2020-039382

(51) Int. Cl. G07F 11/52

(52) U.S. Cl. CPC G07F 11/52

(57) ABSTRACT

There is provided a product storage device for a vending machine capable of changing the length of each of gaps of a spiral member to store products without replacing the spiral member. The spiral member includes a first spiral member and a second spiral member which have the same rotation axis and a gap of the same length. The position of the first spiral member relative to the second spiral member is the rotating direction is changed to change the length of the gap formed by the first spiral member and the second spiral member.

### TECHNICAL FIELD

The present invention relates to a product storage device for a vending machine, more specifically to a product storage device for a vending machine capable of storing products in various sizes, for example, foods packed in boxes, bags, and cups, and beverages packed in cans, bottles, cups and cartons.

### BACKGROUND ART

Conventionally, there has been known, as this sort of product storage device, one including a spiral member formed in a spiral and configured to store products in gaps formed by the spiral and a driving mechanism configured to rotate the spiral member. This product storage device is configured to move the products stored in the gaps by rotating the spiral member based on the driving of the driving mechanism (see, for example, Patent Literature 1).

### CITATION LIST

### Patent Literature

PTL1: Japanese Patent No. 6344427

### SUMMARY OF INVENTION

### Technical Problem

In this conventional product storage device, the gap of the spiral member to store a product has a size corresponding to that of the product. Therefore, when the stored product is changed to a product in a different size, this product storage device has to change the length of the gap to a length corresponding to the size of the changed product.

However, in order to change the length of the gap of the spiral member, the conventional product storage device has no choice but to replace the spiral member with a different one, and therefore causes a problem of increasing the burden on the replacing work by a worker. In addition, the replacement of the spiral member requires a place to keep spare ones. However, when there is no suitable storage place, the spiral member is kept in, for example, a machine space in the vending machine, and a car of the worker in a careless way. This causes a problem that makes it difficult to manage the spiral member.

The present invention has been achieved to solve the above-described conventional problems. It is therefore an object of the present invention to provide a product storage device for a vending machine capable of changing the length of each of the gaps of the spiral member to store products without replacing the spiral member.

### Solution to Problem

To achieve the object, the product storage device for a vending machine according to the present invention includes: a spiral member formed in a spiral and configured to store a product in a gap formed by the spiral; a holding member configured to hold one end of a rotation axis direction of the spiral member; and a driving mechanism configured to rotate the spiral member by rotating the holding member. The spiral member is rotated around a rotation axis based on driving of the driving mechanism to move the product stored in the gap in the rotation axis direction. The spiral member includes a first spiral member and a second spiral member which have the same rotation axis and the gap of the same length. A position of the first spiral member relative to the second spiral member in a rotating direction is changed to change the length of the gap formed by the first spiral member and the second spiral member.

By this means, the product storage device for a vending machine according to the present invention can change the length of each of the gaps formed by the first spiral member and the second spiral member simply by changing the position of the first spiral member relative to the second spiral member in the rotating direction, without replacing the spiral member.

### Advantageous Effect

According to the product storage device for a vending machine according to the present invention, it is possible to change the length of each of the gaps formed by the first spiral member and the second spiral member without replacing the spiral member, and therefore to easily change the stored products to ones in different sizes.

### BRIEF DESCRIPTION OF DRAWINGS

FIG. 1 is a front view illustrating a vending machine;

FIG. 2 is a cross-sectional side view illustrating the vending machine;

FIG. 3A is a perspective view illustrating a first spiral member held by a first holding member;

FIG. 3B is a perspective view illustrating a second spiral member held by a second holding member;

FIG. 4 is a perspective view illustrating the spiral member and the holding member when the vending machine is in the state illustrated in FIG. 2;

FIG. 5 is a top view illustrating the product storage device storing products in the spiral member in the state illustrated in FIG. 4;

FIG. 6 is a perspective view illustrating the first holding member and the second holding member arranged in the direction to engage with one another;

FIG. 7 is a perspective view illustrating the first holding member and the second holding member viewed from a different direction from FIG. 6;

FIG. 8 is a side view illustrating the holding member formed by engaging the first holding member and the second holding member with one another;

FIGS. 9A-9C illustrate the motion of the first holding member when the first holding member is rotated with respect to the second holding member;

FIG. 10 is a perspective view illustrating a state where gaps each having length L₂ are formed between the first spiral member held by the first holding member and the second spiral member held by the second holding member;

FIG. 11 is a top view illustrating the product storage device storing products in the spiral member in the state illustrated in FIG. 10;

FIG. 12 is a perspective view illustrating a state where gaps each having length L₃ and gaps each having length L₄ are formed between the first spiral member and the second spiral member;

FIG. 13 is a top view illustrating the product storage device storing products in the spiral member in the state illustrated in FIG. 12;

FIG. 14 a side view illustrating the vending machine viewed from the right side of its front in a state different from FIG. 2;

FIG. 15 is a perspective view illustrating the whole configuration of an axial position holding member;

FIG. 16 is a perspective view illustrating a state where the axial position holding member is attached to the front end of the rotation axis direction of the spiral member held by the holding member; and

FIG. 17 is a top view illustrating a state where products are stored in the product storage devices including the spiral members with the axial position holding members.

### DESCRIPTION OF EMBODIMENTS

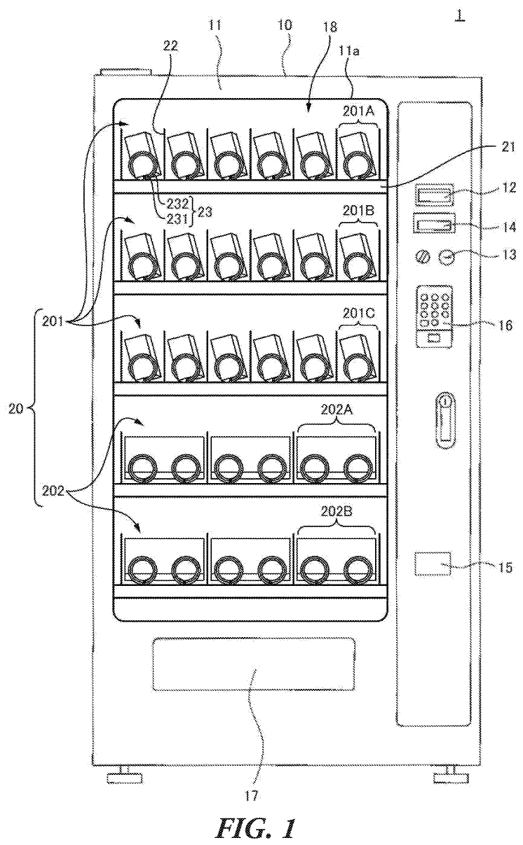

An embodiment of the present invention (hereinafter referred to as “the present embodiment”) will be described with reference to FIGS. 1 to 14.

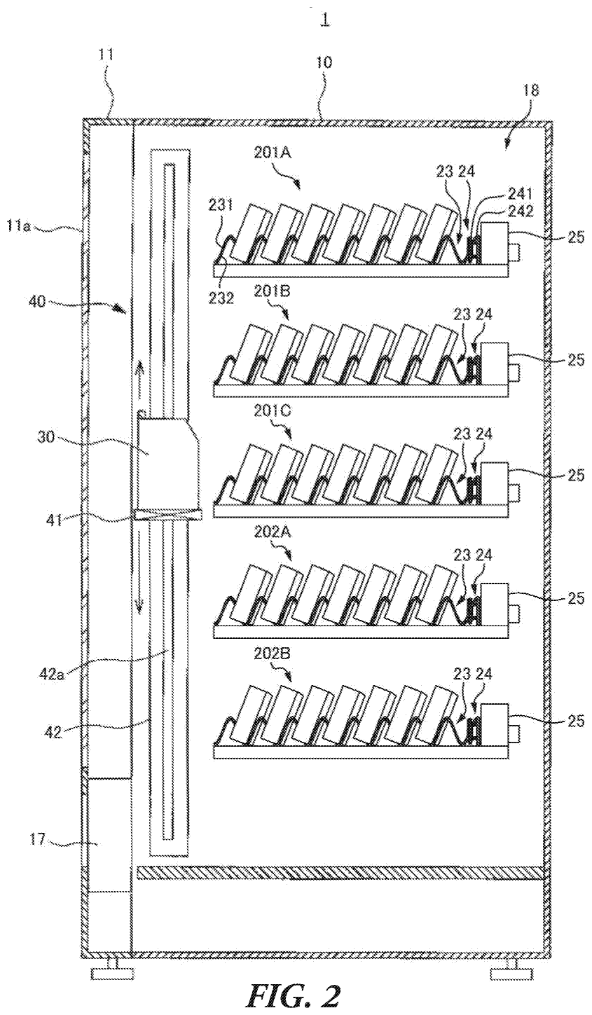

FIG. 1 is a front view illustrating a vending machine 1, and FIG. 2 is a cross-sectional side view illustrating the vending machine 1. As illustrated in FIG. 1 and FIG. 2, the vending machine 1 includes a vending machine body 10 having a front face, part of which is formed by a transparent member to allow the inside to be visible; a plurality of product storage devices 20 disposed in the vending machine body 10; a product bucket 30 configured to receive a product moved or conveyed by each of the product storage devices 20; and a bucket moving mechanism 40 configured to move the product bucket 30 in the up-and-down direction and the right-and-left direction.

The vending machine body 10 includes the front face formed to be open, and is configured to open and close the front face by an outer door 11. A transparent glass window 11a is provided in the outer door 11 except for the lower part and one side part of the front face to allow the inside of the vending machine body 10 to be visible from the outside through the glass window 22a.

In addition, a bill slot 12, a coin slot 13, a money amount display 14, a coin return slot 15, a product selection operating unit 16, and a product takeout port 17 are provided on the front face of the vending machine body 10. Moreover, a product cabinet 18 is provided in the vending machine body 10, and the product storage devices 20 are arranged in the product cabinet 18.

The product storage devices 20 are configured to store boxed products in which foods such as snacks, convenience foods and health foods are packed. The product storage devices 20 are provided in a plurality of rows in the product cabinet 18 in the up-and-down direction, and a plurality of product storage devices 20 are provided in each of the rows in the right-and-left direction. Here, the products are not limited to boxed snacks, but may include various kinds and sizes of products, for example, beverages packed in cans, bottles, cups and cartons, and foods such as snacks, breads, convenience foods and health foods packed in cans, bags and cups.

As illustrated in FIG. 1 or FIG. 2, each of the product storage devices 20 includes a bottom 21 constituting a shelf, side plates 22 provided on both sides in the width direction of the bottom 21, a spiral member 23 formed in a spiral and configured to store products in gaps formed by the spiral, a holding member 24 configured to hold one end of the rotation axis direction of the spiral member 23, and a driving mechanism 25 configured to rotate the holding member 24 to rotate the spiral member 23. This spiral member 23 is disposed in a space formed by the bottom 21 and the side plates 22 provided on both sides in the width direction of the bottom 21.

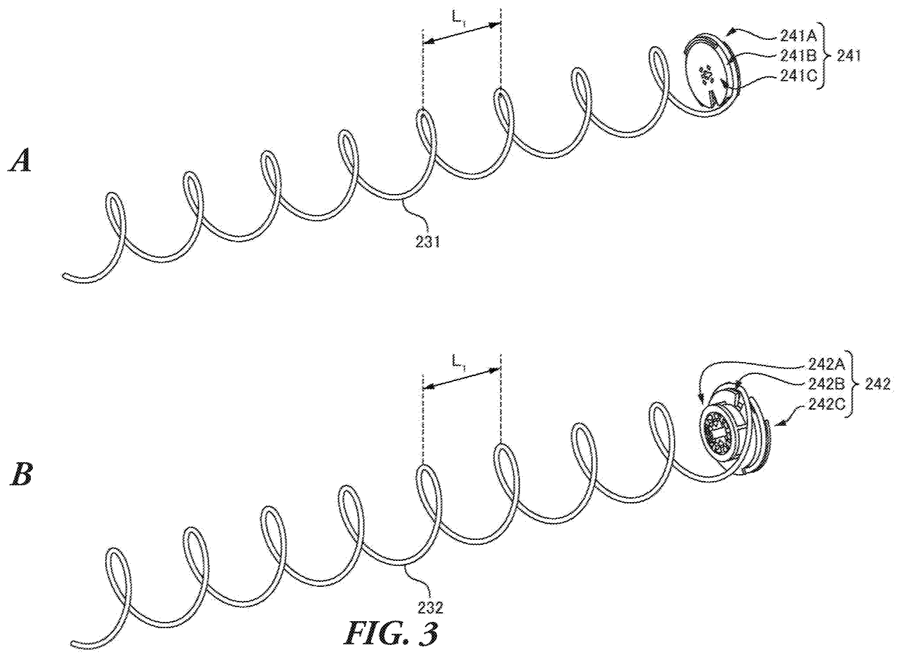

As illustrated in FIGS. 3A-3B described later, the spiral member 23 is composed of a first spiral member 231 forming gaps each of which has length L₁, and a second spiral member 232 forming gaps each of which. has the same length L₁ and having a spiral diameter slightly greater than that of the first spiral member 231. The first spiral member 231 having the spiral diameter smaller than that of the second spiral member 232 is disposed inside the second spiral member 232 to overlap one another, and therefore to form the spiral member 23 as a double spiral member.

As illustrated in FIG. 1, product storage devices 201 are provided in the first to third rows from the top of the product cabinet 18. Each of the product storage devices 201 is configured to store one product in a gap formed by one double spiral member 23. Then, product storage devices 202 are provided in the fourth and fifth rows from the top of the product cabinet 18. Each of the product storage devices 202 is configured to store one product in a gap formed by two double spiral members 23 which have coiling directions different from one another.

The side view of FIG. 2 illustrates the rightmost product storage devices 20, which are product storage devices 201A, 201B, and 201C provided in the first to third rows from the top of the product cabinet 18, and product storage devices 202A and 202B provided in the fourth and fifth rows from the top of the product cabinet 18 here, the product storage devices 201 will be mainly described in detail.

The holding member 24 is formed by engaging a first holding member 241 configured to attach and hold one end of the rotation axis direction of the first spiral member 231 with a second holding member 242 configured to attach and hold one end of the rotation axis direction of the second spiral member 232. The holding member 24 holding the spiral member 23 composed of the first spiral member 231 and the second spiral member 232 is attached to the driving mechanism 25.

The driving mechanism 25 includes a rotatable motor (not illustrated). When the motor of the driving mechanism 25 rotates, the holding member 24 attached to the driving mechanism 25 is rotated in a predetermined rotating direction. By this means, the spiral member 23 held by the holding member 24 is rotated in the predetermined rotating direction accordingly. In this way, the first spiral member 231 and the second spiral member 232 constituting the spiral member 23 are rotated around the same rotation axis in the same rotating direction.

As illustrated in FIG. 2, in the vending machine 1, the product bucket 30 is disposed in a space between the back surface of the outer door 11 and the product storage devices 20 and moved by the bucket moving mechanism 40 in the up-and-down direction and the right-and-left direction.

The bucket moving mechanism 40 includes a right-and-left driving part 41 configured to move the product bucket 30 in the right-and-left direction, and a pair of right and left up-and-down driving parts 42 configure. to move the right-and-left driving part 41 in the up-and-down direction. Each of the up-and-down driving parts 42 is disposed in the vending machine body 10 on. both sides in the width direction. The right-and-left driving part 41 movably supports the product bucket 30 by a guide rail (not illustrated) extending in the right-and-left direction, and is configured to move the product bucket 30 along the guide rail in the right-and-left direction by a right-and-left moving motor (not illustrated). Each of the up-and-down driving parts 42 movably supports the right-and-left driving part 41 by a guide rail 42a extending in the up-and-down direction, and is configured to move the product bucket 30 along the guide rail 42a in the up-and-down direction by an up-and-down. moving motor (not illustrated).

In the vending machine 1 having the above-described configuration, when money is received and a product is selected by the product selection operating unit 16, the driving mechanism 25 rotates the motor in the positive direction based on a signal from the product selection operating unit 16 to rotate the holding member 24 in a predetermined rotating direction, and thereby to rotate the double spiral member 23 in the predetermined rotating direction, accordingly.

By this means, the product stored in the gap of the spiral member 23 is moved to the front side of the vending machine body 10. Accordingly, the product bucket 30 is moved to the product storage device 20 corresponding to the selected product by the bucket moving mechanism 40. Then, the product bucket 30 receives the product from the product storage device 20. The product bucket 30 having the product is moved to the product takeout port 17 by the bucket moving mechanism 40, and the product in the product bucket 30 is discharged to the product takeout port 17.

Next, the details of the spiral member 23 will be described with reference to FIG. 3. FIG. 3A is a perspective view illustrating the first spiral member 231 held by the first holding member 241, FIG. 3B is a perspective view illustrating the second spiral member 232 held by the second holding member 242.

As illustrated in FIG. 3A and FIG. 3B, each of the first spiral member 231 and the second spiral member 232 includes seven gaps which are formed by the spiral and configured to be able to store products. The length of each of the gaps is L₁.

Here, the number of the gaps of each of the first spiral member 231 and the second spiral member 232 formed by the spiral is seven. However, this is by no means limiting. In addition, the length of the gap may be any value.

As illustrated in FIG. 3A, one end of the rotation axis direction of the first spiral member 231 is attached to a side surface 241B of the first holding member 241, so that the first spiral member 231 is held by the first holding member 241. This first holding member 241 holds the first spiral member 231 such that a non-engagement portion 241C opposite to an engagement potion 241A configured to engage with the second holding member 242 faces the coiling direction of the first spiral member 231.

Meanwhile, as illustrated in FIG. 3B, the second holding member 242 holds the second spiral member 232 by attaching one end of the rotation axis direction of the spiral member 232 to a side surface 242B. This second holding member 242 holds the second spiral member 232 such that an engagement portion 242A configured to engage with the first holding member 241 faces the coiling direction of the second spiral member 232. Moreover, a non-engagement portion 242C opposite to a front surface 242A of the second holding member 242 is attached to the driving mechanism 25.

The spiral diameter of the second spiral member 232 is slightly greater than that of the first spiral member 231, and therefore the outer diameter of the side surface 242B of the second holding member 242 is slightly greater than that of the side surface 241B of the first holding member 241, accordingly.

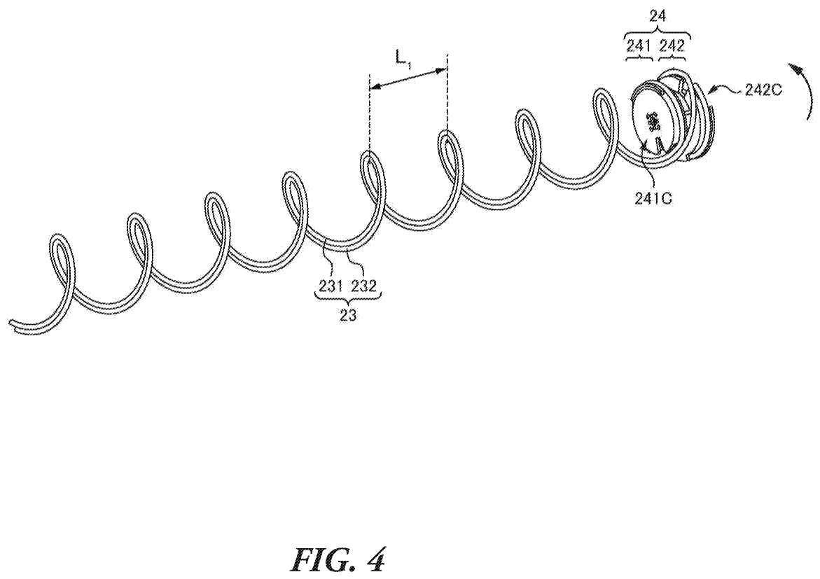

FIG. 4 is a perspective view illustrating the spiral member 23 and the holding member 24 when the vending machine is in the state illustrated in FIG. 2. After the first holding member 241 attached to the first spiral member 231 and the second holding member 242 attached to the second spiral member 232 are engaged with one another, the first holding member 241 is rotated with respect to the second holding member 242. As a result, it is possible to arrange the first spiral member 231 and the second spiral member 232 overlapping one another as illustrated in FIG. 4

The spiral member 23 illustrated in FIG. 4 is in a state where no gap is formed between the first spiral member 231 and the second spiral member 232. Therefore, the spiral member 23 in this state forms seven gaps which can store products, and the length of each of the gaps of the first spiral member 231 is L₁ which is the same as that of the second spiral member 232.

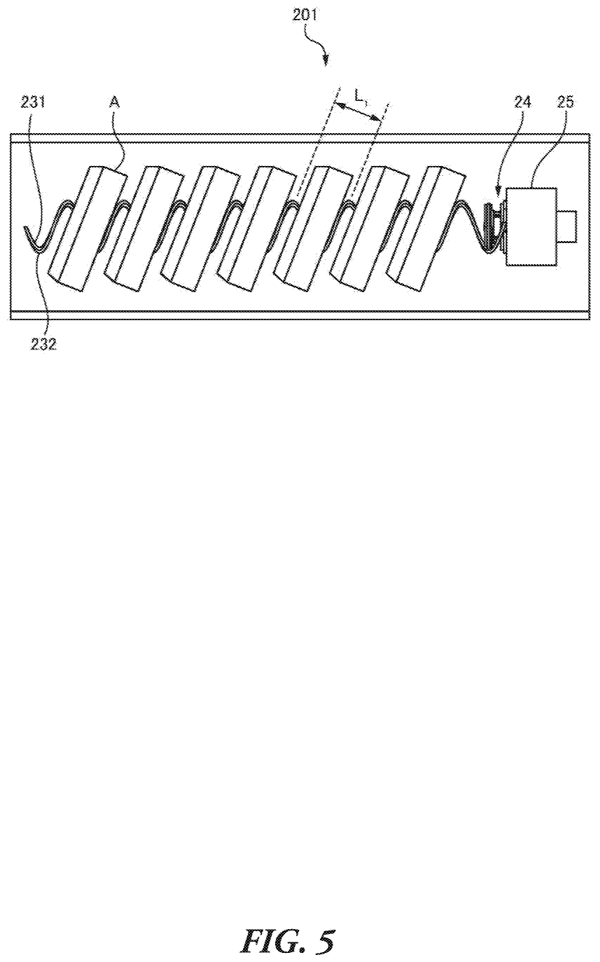

FIG. 5 is a top view illustrating the product storage device 201 storing products in the spiral member 23 in the state illustrated in FIG. 4. Each of the seven gaps having the length L₁ of the spiral member 23 can store product A having a thickness corresponding to the length 11. That is, the spiral member 23 can store a maximum of seven products each having the thickness corresponding to the length L₁.

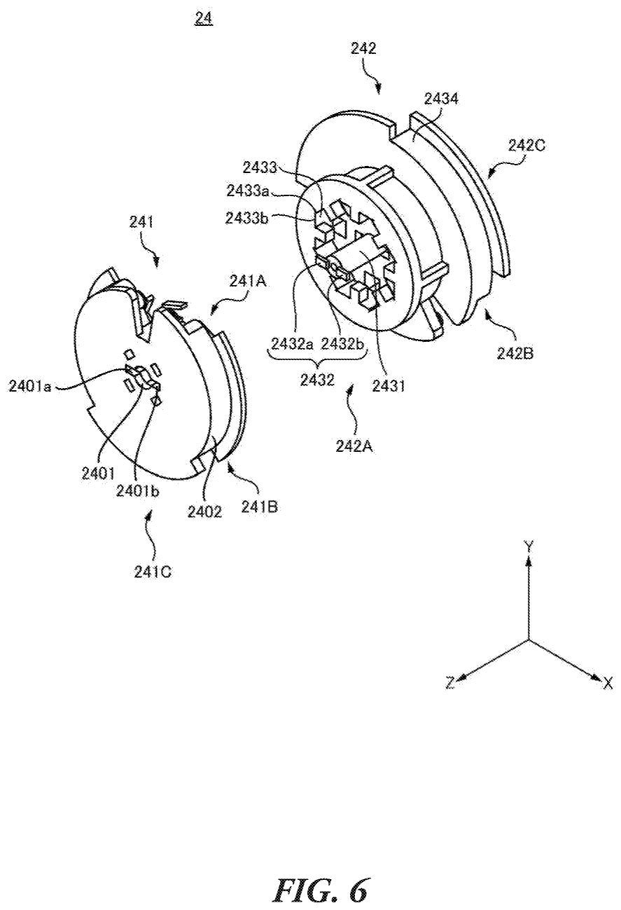

Next, the first holding member 241 and the second holding member 242 constituting the holding member 24 will be described with reference to FIG. 6 to FIGS. 9A-9C.

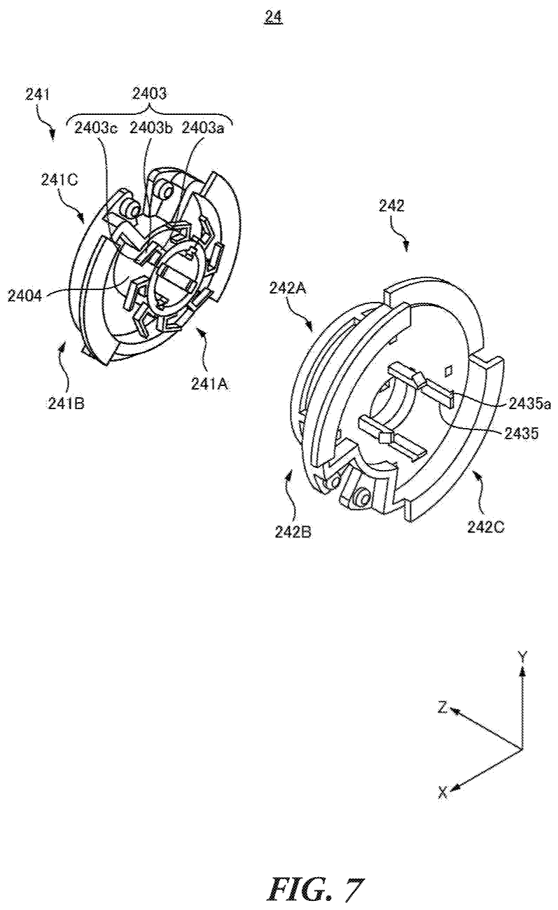

FIG. 6 is a perspective view illustrating the first holding member 241 and the second holding member 242 arranged in a direction (Z-axis direction of XYZ coordinate plane) to engage with one another. FIG. 7 is a perspective view illustrating the first holding member 241 and the second holding member 242 viewed from a different direction from FIG. 6.

FIG. 6 illustrates the non-engagement portion 241C of the first holding member 241. The first holding member 241 includes a through-hole 2401 formed in the non-engagement portion 241C to engage with the second holding member 242. The through-hole 2401 includes a first square hole 2401a and a second square hole 2401b. The first holding member 241 can rotate with respect to the second holding member 242 around a rotation axis passing through the center point in the through-hole 2401.

In addition, as illustrated in FIG. 6, the side surface 241B of the first holding member 241 includes a first spiral holding portion. 2402 configured to attach and hold one end of the rotation axis direction of the first spiral member 231.

Moreover, FIG. 6 illustrates the engagement portion 242A of the second holding member 242. The second holding member 242 includes a protrusion 2431 and a fixed portion 2432 formed in the engagement portion 242A. The protrusion 2431 is inserted into the through-hole 2401 of the first holding member 241, and the fixed portion 2432 is provided on the tip of the protrusion 2431. The fixed portion 2432 includes a first fixed portion 2432a and a second fixed portion 2432b inserted into one of the first square hole 2401a and the second square hole 2401b and rotated to be fixed. In addition, the front surface 242A of the second holding member 242 includes grooves 2433 each including a locked groove (locked portion) 2433a and an inner wall 2433b.

Moreover, as illustrated FIG. 6, the side surface 242B of the second holding member 242 includes a second spiral holding portion 2434 configured to attach and hold one end of the rotation axis direction of the second spiral member 232.

FIG. 7 illustrates the engagement portion 241A of the first holding member 241. The first holding member 241 includes eight locking portions 2403 formed on the engagement portion 241A every predetermined rotation angle (45 degrees) with respect to the center of the rotation of the first holding member 241. Each of the locking portion 2403 includes a base 2403a approximately radially extending from an outer circumference 2404 having the same center point as the first holding member 241, and a bending portion 2403b bending from the front end of the base 2403a in the direction opposite to the rotating direction of the first holding member 241. A locking tip 2403c forming an acute angle is formed on the front end of the bending portion 2403b. When the first holding member 241 and the second holding member 242 are engaged with one another, the locking portions 2403 are inserted in the grooves 2433 of the front surface 242A of the second holding member 242.

FIG. 7 illustrates the non-engagement portion 242C of the second holding member 242. Four protrusions 2435 which can be attached to the driving mechanism 25 are provided on the non-engagement portion 242C every predetermined rotation angle (90 degrees) with respect to the center of the rotation of the second holding member 242. Each of the protrusions 2435 includes a claw 2435a formed on its front end and configured to be attached to the driving mechanism 25.

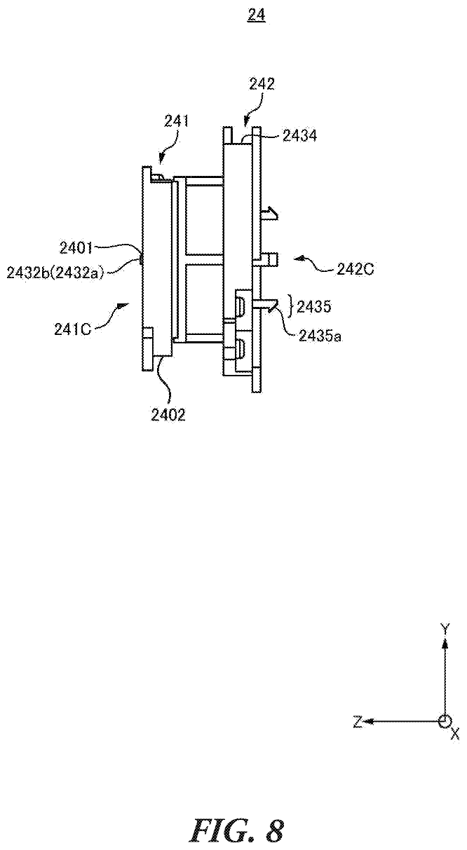

FIG. 8 is a side view illustrating the holding member 24 formed by engaging the first holding member 241 and the second holding member 242 with one another. When the first holding member 241 and the second holding member 242 are engaged with one another, the protrusion 2431 of the engagement portion 242A of the second holding member 242 is inserted into the through-hole 2401 of the engagement portion 241A of the first holding member 241. In this case, the first fixed portion 2432a and the second fixed portion 2432b of the protrusion 2431 are inserted into the first square hole 2401a and the second square hole 2401b of the through-hole 2401, and therefore are exposed from the non-engagement portion 241C, as illustrated in FIG. 8.

In this state, when the first holding member 241 is rotated with respect to the second holding member 242, the first fixed portion 2432a and the second fixed portion 2432b are rotated according to the rotation, to rotation angle positions which are different from the positions of the first square hole 2401a and the second square hole 2401b of the non-engagement portion 2410. Then, even when the second holding member 242 is tried to be removed from the first holding member 241, the first fixed portion 2432a and the second fixed portion 2432b are locked to the non-engagement portion 241C, and therefore cannot be removed. By this means, the first holding member 241 and the second holding member 242 engaged with one another are fixed.

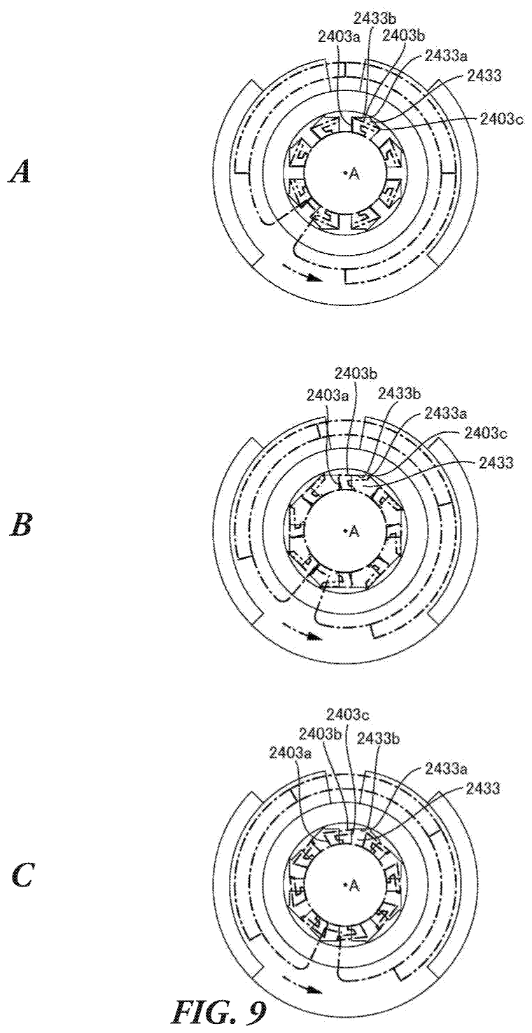

FIGS. 9A-9C illustrate the motion of the first holding member 241 of the holding member 24 when the first holding member 241 is rotated with respect to the second holding member 242. FIGS. 9A-9C illustrate essential parts of the holding member 24 for explanation, viewed from the non-engagement portion 241C side of the first holing member 241. Here, the inside of the holding member 24 formed by engaging the first holding member 241 and the second holding member 242 with one another cannot be visually recognized. Therefore, FIGS. 9A-9C illustrate the essential parts including the inside of the holding member 24 which cannot be visually recognized for explanation. In FIGS. 9A-9C, the essential parts of the first holding member 241 are indicated by alternate long and short dash lines, and those of the second holding member 242 are indicated by solid lines.

As illustrated in FIG. 9A, when the first holding member 241 is engaged with the second holding member 242, the locking portions 2403 of the first holding member 241 are inserted in the grooves 2433 of the second holding member 242. Then, the first holding member 241 is rotated with respect to the second holding member 242 around the rotation axis passing through center point A in the rotating direction indicated by an arrow.

As a result, the locking tips 2403c of the locking portions 2403 are locked in the locked grooves 2433a of the grooves 2433, and therefore the first holding member 241 cannot be rotated in the direction opposite to the rotating direction indicated by an arrow as illustrated in FIG. 9B. Consequently, the locking tips 2403c are locked in the locked grooves 2433a every time the first holding member 241 is rotated with respect to the second holding member 242 for 45 degrees in the rotating direction indicated by the arrow, so that the first holding member 241 is restricted from rotating in the direction opposite to the rotating direction indicated by the arrow.

By this means, the first holding member 241 can be rotated only in the rotating direction indicated by the arrow. When the first holding member 241 is rotated in this rotating direction, the bending portions 2403b are bent toward the center point A while the locking tips 2403c contact the inner walls 2433b of the grooves 2433, and therefore the first holding member 241 is smoothly rotated in the rotating direction indicated by an arrow as illustrated in FIG. 9C.

When the first holding member 241 is rotated with respect to the second holding member 242 for any rotation angle in a predetermined. rotating direction, the first spiral member 231 held by the first holding member 241 is also rotated with respect to the second holding member 232 for the same rotation angle in the predetermined rotating direction, accordingly. The rotation of the first spiral member 231 with respect to the second spiral member 232 forms gaps between the first spiral member 231 and the second spiral member 232, and each of the gaps has a length corresponding to the rotation angle. In this way, the position of the first spiral member 231 relative to the second spiral member 232 in the rotating direction is changed, and therefore the length of each of the gaps formed by the first spiral member 231 and the second spiral member is changed.

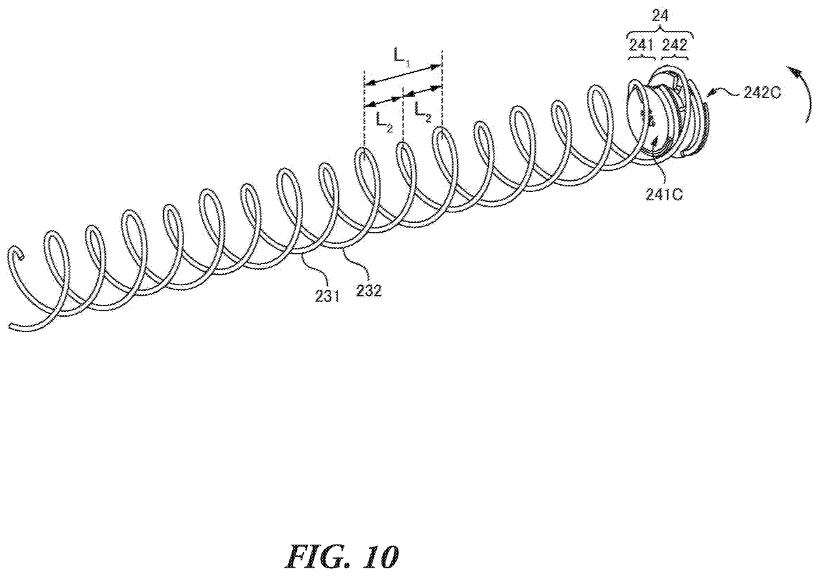

FIG. 10 is a perspective view illustrating a state where gaps each of which. has length L₂ are formed. between the first spiral member 231 held by The first holding member 241 and the second spiral member 232 held by the second holding member 242.

In a case where the spiral member 23 and the holding member 24 are in the state illustrated in FIG. 4, when the first holding member 241 is rotated with respect to the second holding member 242 around a rotation axis which is the same as the rotation axis passing through the center point A for 180 degrees in the rotating direction indicated by the arrow, the first spiral member 231 is also rotated with respect to the second spiral member 232 for 180 degrees in the same rotating direction, accordingly. By this means, gaps each of which has length L₂ are formed between the first spiral member 231 and the second spiral member 232 as illustrated in FIG. 10. This length L₂ is ½ of L₁ which is the length of each of the gaps formed by the first spiral member 231 and the gaps formed by the second spiral member 232. By this means, the spiral member 23 in the state illustrated in FIG. 10 has fourteen gaps each having the length L₂.

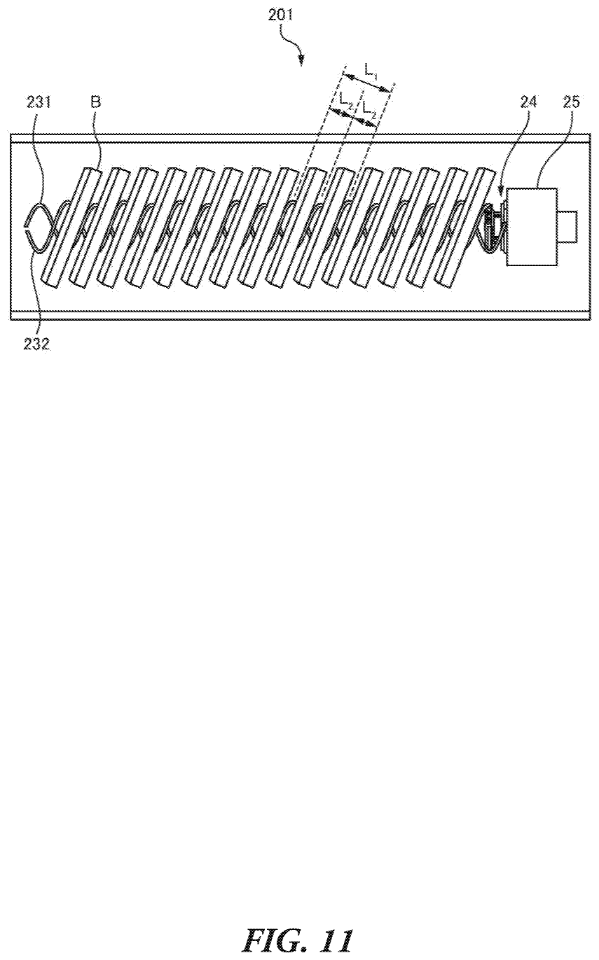

FIG. 11 is a top view illustrating the product storage device 201 storing products in the spiral member 23 in the state illustrated in FIG. 10. Each of the fourteen gaps of the spiral member 23 having the length L₂ can store product B having a thickness corresponding to the length L₂. That is, the length of each of the gaps of the spiral member 23 is changed from the length L₁ to the length L₂ which is ½ of L₁, and therefore the product storage device 201 can store fourteen products B each of which has a thickness ½ of product A and which are twice as much as products A.

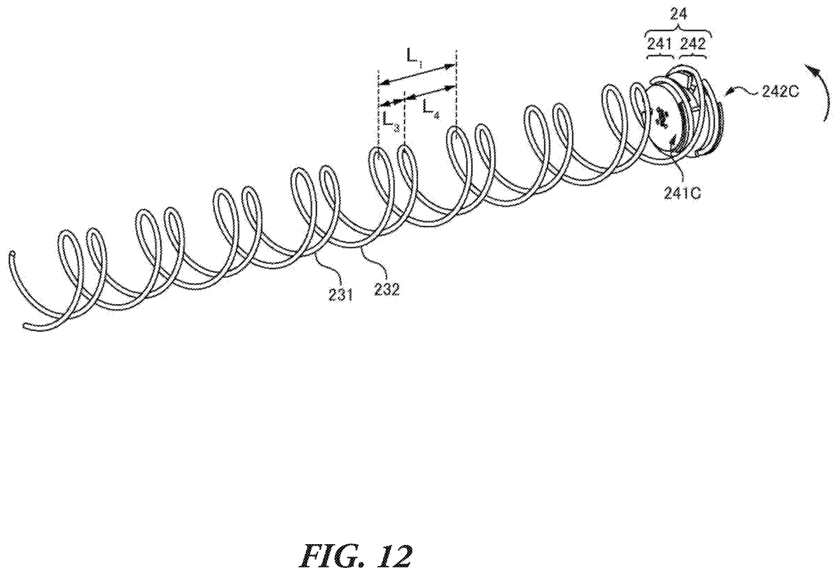

FIG. 12 is a perspective view illustrating a state where gaps each of which has length L₃ and gaps each of which has length L₄ are formed between the first spiral member 231 and the second spiral member 232.

In a case where the spiral member 23 and the holding member 24 are in the state illustrated in FIG. 4, when the first holding member 241 is rotated with respect to the second holding member 242 around the rotation axis passing through the center point A for 240 degrees in the rotating direction indicated by the arrow, the first spiral member 231 is also rotated with respect to the second spiral member 232 for 240 degrees in the same rotating direction, accordingly. By this means, gaps each of which has the length L₃ and gaps each of which has the length L₄ are formed between the first spiral member 231 and the second spiral member 232 as illustrated in FIG. 12. The length L₃ is ⅓ of L₁ which is the length of each of the gaps formed by the first spiral member 231 and the gaps formed by the second spiral member 232. The length L₄ is ⅔ of L₁. By this means, the spiral member 23 in the state illustrated in FIG. 12 has seven gaps each having the length L₃ and seven gaps each having the length L₄.

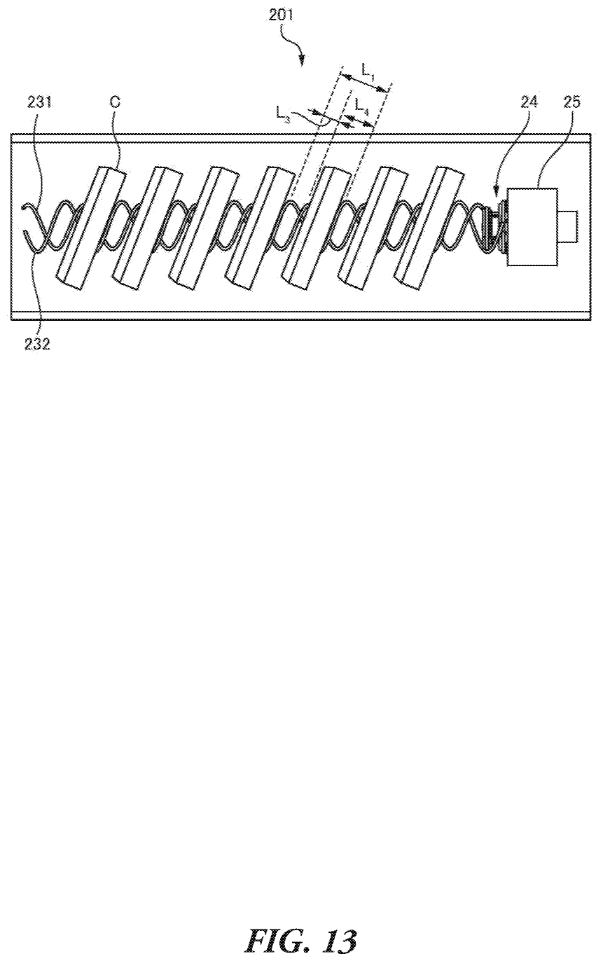

FIG. 13 is a top view illustrating the product storage device 201 storing products in the spiral member 23 in the state illustrated in FIG. 12. Each of the seven gaps having the length L₄ of the spiral member 23 illustrated in FIG. 13 can store product C having a thickness corresponding to the length L₄. That is, the length of each of the gaps of the spiral member 23 is changed from the length L₁ to the length L₄ which is ⅔ of L₁, and therefore the product storage device 201 can store seven products C each of which has a thickness ⅔ of the product A.

The product storage device 201 in the state illustrated in FIG. 13 store no product in the seven gaps of the spiral member 23 each of which has the length L₃. By this means, it is possible to widen the distance between the products C in the product storage device 201, and therefore to realize spacious product storage that prevents the products C from contacting each other. In addition, this product storage can make it easy to show the products stored behind the front row to consumers. However, this is by no means limiting, but products each of which has a thickness corresponding to the length L₃ of the spiral member 23 may be stored in the gap having the length L₃.

In this way, the position of the first spiral member 231 relative to the second spiral member 232 in the rotating direction is changed, and therefore the product storage device 201 can change the length of each of the gaps formed by the first spiral member 231 and the second spiral member 232 according to the size of stored products.

As described above, in the fourth and fifth rows from the top of the product cabinet 18 illustrated in FIG. 1, the product storage devices 202 configured to store one product in each of the gaps formed by two double spiral members 23 having the coiling directions different from one another. In this product storage device 202, the above-described double spiral member 23 and a double spiral member (not illustrated) having the opposite coiling direction are rotated in the rotating directions opposite to one another to move the stored products. Here, each of the two double spiral members of the product storage device 202 forms gaps each having the length L₁.

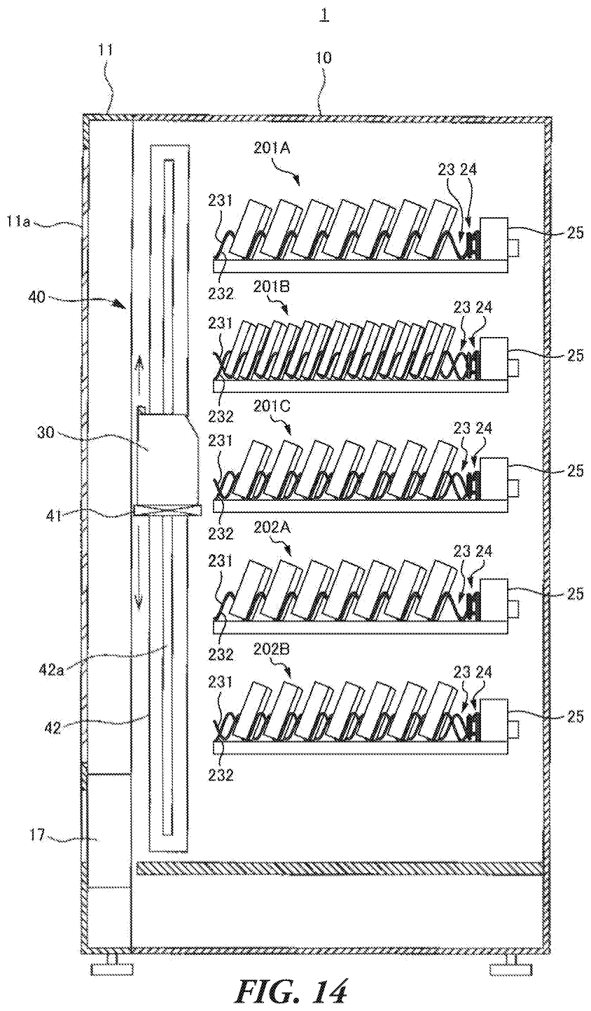

FIG. 14 is a side view illustrating the vending machine 1 viewed from the right side of its front, like FIG. 2. The side view of FIG. 14 illustrates a state where the length of each of the gaps of the spiral member 23 of a product storage device 20B is changed from the length to the length L₂ (see FIG. 10); the length of each of the gaps of the spiral member 23 of the product storage device 20C is changed from the length L₁ to the length L₃ and the length L₄ (see FIG. 12); and the length of each of the gaps of the two double spiral members of the product storage device 202B is changed from the length L₁ to the length L₃ and the length L₄.

As described above, according to the product storage device 20, when the length of each of the gaps formed by the first spiral member 231 and the second spiral member 232 is changed to any length, it is possible to change the length by a simple operation, for example, by simply rotating the first holding member 241 with respect to the second holding member 242 for any rotation angle. By this means, it is possible to change the length of each of the gaps of the spiral member 23 without replacing the spiral member 23, and therefore to easily change the stored products to products in different sizes.

With the above-described embodiment, an example where the first holding member 241 is rotated with respect to the second holding member 242 has been described, but this is by no means limiting. For example, the second holding member 242 may be rotated with respect to the first holding member 241 in the direction opposite to the rotating direction of the first holding member 241. Even when the second holding member 242 is rotated with respect to the first holding member 241, it is also possible to set the length of each of the gaps formed between the first spiral member 231 and the second spiral member 232 in the same way as the above-described example.

In addition, with the above-described embodiment, the spiral diameter of the second spiral member 232 is slightly greater than that of the first spiral member 231, but this is by no means limiting. For example, the spiral diameter of the first spiral member 231 may be the same as that of the second spiral member 232.

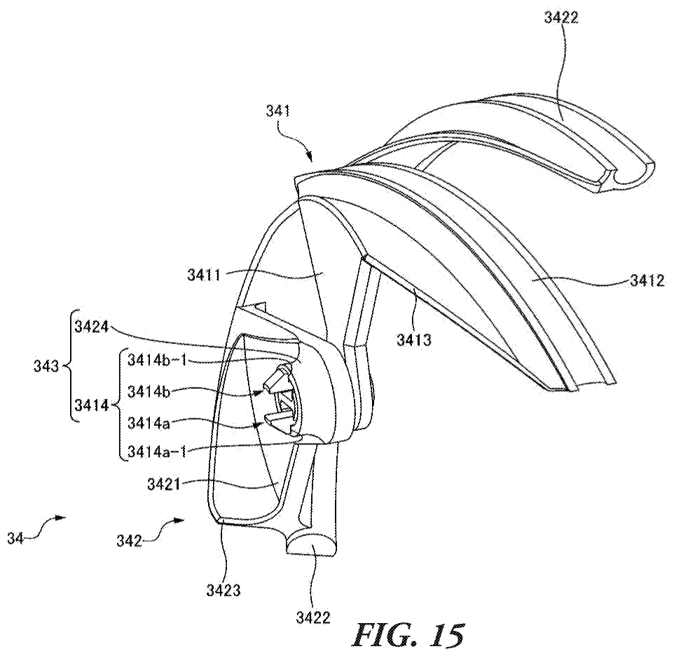

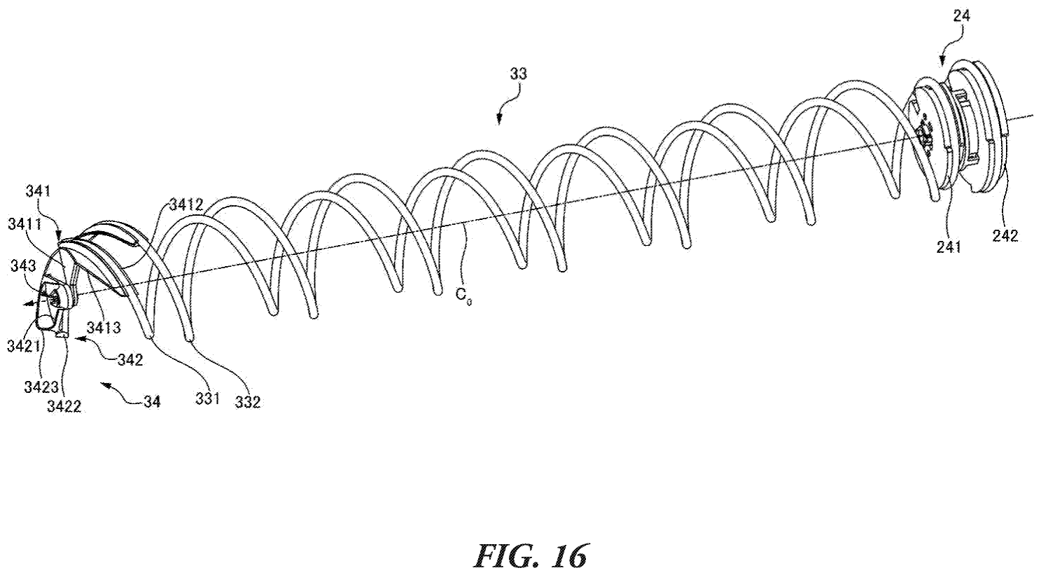

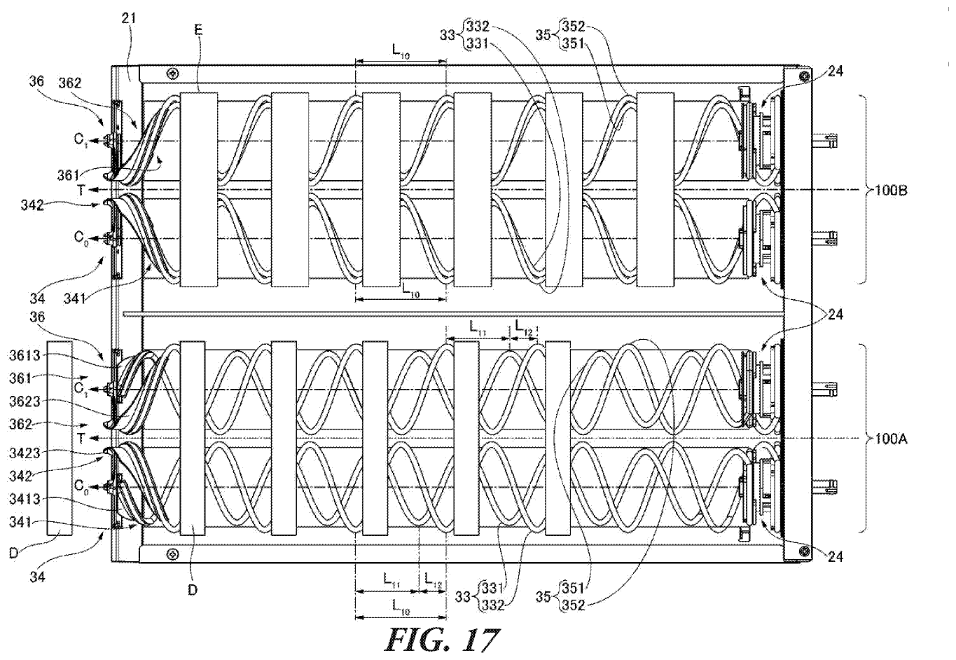

Moreover, the vending machine may include the product storage device including an axial position holding member as described next. FIG. 15 is a perspective view illustrating the whole configuration of the axial position holding member. FIG. 16 is a perspective view illustrating a state where the axial position holding member is attached to the front end of the rotation axis direction of the spiral member held by the holding member (here, the front end (the other end) is opposite to the rear end (one end) held by the holding member). FIG. 17 is a top view illustrating a state where products are stored in the product storage devices including the spiral members with the axial position holding members.

As illustrated in FIG. 15, an axial position holding member 34 includes a first axis holding member 341 and a second axis holding member 342. The first axis holding member 341 and the second axis holding member 342 are coupled to one another by, a coupling portion 343, and thereby to be able to rotate with respect to one another.

This axis position holding member 34 is made of an elastic material, for example, synthetic resin such as polycarbonate.

The first axis holding member 341 includes a first rotating plate 3411, a first attachment 3412, a first pushing piece 3413, and a coupling protrusion 3414. Meanwhile, the second axis holding member 342 includes a second rotating plate 3421, a second attachment 3422, a second pushing piece 3423, and a coupling hole 3424.

The coupling portion 343 includes the coupling protrusion 3414 and the coupling hole 3424. The coupling protrusion 3414 is inserted into the coupling hole 3424 while a first coupling protrusion 3414a and a second coupling protrusion 3414b each formed in a triangle with an acute vertex angle are bent, and a first hook claw 3414a-1 and a second hook claw 3414b-1 are hooked over the hole rim of the coupling portion 3424 to restrict the motion in the direction opposite to the insertion direction, and consequently to be coupled to the coupling hole 3424. The first axis holding member 341 and the second axis holding member 342 are rotatably coupled to one another by this coupling portion 343.

The first rotating plate 3411 of the first axis holding member 341 is a plane which is adjacent to the coupling protrusion 3414 and spreads to form a fan-like shape, and the front end. of the first rotating plate 341 forming the circular arc of the fan-like shape connects to the first pushing piece 3413. The first attachment 3412 has a groove that can be attached to the front end (the other end) of the rotation axis direction of the first spiral member 331. The first pushing piece 3413 is formed along one side of the groove of the first attachment 3412. Likewise, the second rotating plate 3421 of the second axis holding member 342 is a plane which is adjacent to the coupling hole 3424 and spreads to form a fan-like shape, and the front end of the second rotating plate 3421 forming the circular arc of the fan-like shape connects to the second pushing piece 3423. The second attachment 3422 has a groove that can be attached to the front end (the other end) of the rotation axis direction. of the second spiral member 332. The second pushing piece 3423 is formed along one side of the groove of the second attachment 3422.

The axial position holding member 34 having this configuration is attached to the front end of the rotation axis direction of a double spiral member 33 held by the holding member 24 as illustrated in FIG. 16. In this case, the front end of the rotation axis direction of the first spiral member 331 is fitted in the groove of the first attachment 3412 while the front end of the rotation axis direction of the second spiral member 332 is fitted in the groove of the second attachment 3422, so that the first attachment 3412 and the second attachment 3422 are fixed to the front end of the rotation axis direction of the spiral member 33. In this axial position holding member 34 illustrated in FIG. 16, the first axis holding member 341 revolves with respect to the second axis holding member 342 according to the rotation of the first holding member 241 with respect to the second holding member 242.

This axial position holding member 34 restricts the free motion of the front end of each of the first spiral member 331 and the second spiral member 332 to align the rotation axes of the first spiral member 331 and the second spiral member 332 with rotation axis C₀, while the first axis holding member 341 is attached to the front end (the other end) of the rotation axis direction of the first spiral member 331 and the second axis holding member 342 is attached to the front end (the other end) of the rotation axis direction of the second spiral member 332. These first spiral member 331 and. second spiral member 332 are held in the state where they have the same rotation axis C₀ even when the position of the first spiral member 331 relative to the second spiral member 332 in the rotating direction is changed.

The vending machine 1 includes product storage devices 100A and 100B as illustrated in FIG. 17. Each of the product storage devices 100A and 100B includes the double spiral member 33 including the first spiral member 331 and the second spiral member 332, and a double spiral member 35 including a first spiral member 351 and a second spiral member 351. The first spiral member 351 and the second spiral member 351 have a coiling direction opposite to that of the first spiral member 331 and the second spiral member 332 with respect to symmetric axis T. As illustrated in FIG. 17, each of the product storage devices 100A and 100B stores one product in each of gaps formed by the two double spiral members 33 and 35. The product storage devices 100A and 100B are installed in the vending machine 1 such that the rear end (one end) of the rotation axis direction of each of the spiral members 33 and 35 held by the holding members 24 is located in the back side of the vending machine 1 and the front end (the other end) of the rotation axis direction of each of the spiral members 33 and 35 is located in the front side of the vending machine 1.

In each of the product storage devices 100A and 100B, the axial position holding member 34 is attached to the front end of the rotation axis direction of the spiral member 33. Meanwhile, an axial position holding member 36 is attached to the front end of the rotation axis direction of the spiral member 35. The axial position holding member 36 and the axial position holding member 34 are symmetrical to one another with respect to the symmetric axis T. To be more specific, a first axis holding member 361 which is symmetrical to the first axis holding member 341 with respect to the symmetric axis T is attached to the first spiral member 351, while a second axis holding member 362 which is symmetrical to the second axis holding member 342 with respect to the symmetric axis T is attached to the second spiral member 352.

In the product storage device 100A illustrated in FIG. 17, the two double spiral members 33 and 35 form gaps according to the rotation of the first holding member 241 with respect to the second holding member 242 in a definite direction. For example, by rotating the first holding member 241 with respect to the second holding member 242 for 240 degrees, gaps each having length L₁₁, and gaps each having length L₁₂ are formed between the first spiral member 331 and the second spiral member 332, and between the first spiral member 351 and the second spiral member 352 (here, the length L₁₁ is ⅔ of the length L₁₀ of each of the gaps formed by the first spiral members 331 and 351, and the second spiral members 332 and 352, and the length L₁₂ is ⅓ of the Length L₁₀).

Meanwhile, in the product storage device 100B, the two double spiral members 33 and 35 form no gap between the first spiral member 331 and the second spiral member 332, and between the first spiral member 351 and the second spiral member 352.

In the product storage device 100B, each of the gaps having the length L₁₀ formed by the spiral members 33 and 35 stores product E having a thickness corresponding to the length L₁₀ of the gap. In the product storage device 100A, each of six gaps having the length L₁₁ formed by the spiral members 33 and 35 stores product D having a thickness corresponding to the length L₁₁, that is, a thickness ⅔ of that of the product E.

In each of the product storage devices 100A and 100B, the rotation axes of the first spiral member 331 and the second spiral member 332 are aligned with the rotation axis C₀ by the axial position holding member 34, and the rotation axes of the first spiral member 351 and the second spiral member 352 are aligned with the rotation axis C₁ by the axial position holding member 36. By this means, even when the position of the first spiral member 331 relative to the second spiral member 332 in the rotating direction is changed and the position of the first spiral member 351 relative to the second spiral member 352 in the rotating direction is changed, the product storage devices 100A and 100B maintain state where the first spiral member 331 and the second spiral member 332 have the same rotation axis C₀, and the first spiral member 351 and the second spiral member 352 have the same rotation axis C₁.

Therefore, when gaps each having a desired length for storing products are formed by the spiral members 33 and 35, it is possible to securely keep the desired length of the gap at any position of the rotation axis directions of the spiral members 33 and 35.

For example, as the product storage device 100A illustrated in FIG. 17, when gaps each having the length L₁₁, and gaps each having the length L₁₂ are formed between the first spiral member 331 and the second spiral member 332, and between the first spiral member 351 and the second spiral member 352, it is possible to stably maintain the repetition of the gaps having the length L₁₁ and the gaps having the length L₁₂ at any position of the rotation axis direction of each of the spiral members 33 and 35.

These product storage devices 100A and 100B can store products each having a thickness corresponding to the length of the gap at any position of the rotation axis direction of each of the spiral members 33 and 35.

Moreover, in each of the product storage devices 100A and 100B, the first pushing piece 3413 and the second pushing piece 3423 of the axial position holding member 34 project from the double spiral member 33 in the moving direction of the products (the direction toward the front side of the vending machine 1). Likewise, the first pushing piece 3613 and the second pushing piece 3623 of the axial position holding member 36 also project from the double spiral member 35 in the moving direction of the products. To be more specific, as illustrated in FIG. 17, the front end of each of the first pushing piece 3413, the second pushing piece 3423, the first pushing piece 3613, and the second pushing piece 3623 projects forward from the front end of the bottoms 21 of the product storage devices 100A and 100B. When the spiral members 33 and 35 are rotated, these pushing pieces can push the product stored in the gap formed by the spiral members 33 and 35 to drop the product from the front end of each of the product storage devices 100A and 100B into the product bucket 30.

For example, it is assumed that the product D stored in the gap formed by the spiral members 33 and 35 is moved to the attached positions of the axial position holding members 34 and 36 of the spiral members 33 and 35 by the rotation of the spiral members 33 and 35 in the product storage device 100A. In this case, one or more of the first pushing piece 3413, the second pushing piece 3423, the first pushing piece 3613, and the second pushing piece 3623 push the moved product D, so that the axial position holding members 34 and 36 can drop the product D from the front end of the product storage device 100A into the product bucket 30.

By this means, the product storage device 100A can prevent the situation where the product D is not dropped into the product bucket 30 but stays in the product storage device 100A. As a result, the product storage device 100A can surely drop the product D into the product bucket 30 to allow the product D to be received in the product bucket 30. This effect can also be obtained from the product storage device 1003 having the same configuration as the product storage device 100A.

Here, instead of the example described above, the pushing piece may be provided in one of the first axis holding member 341 and the second axis holding member 342 of the axial position holding member 34, and/or one of the first axis holding member 361 and the second axis holding member 362 of the axial position holding member 36.

Moreover, instead of the example illustrated in FIG. 17, when the product storage device is configured to store one product in one double spiral member, the axial position holding member may be attached to the front end of the rotation axis direction of the double spiral member.

### REFERENCE SIGNS LIST

1 vending machine, 10 vending machine body, 11 outer door, 11a glass window, 12 bill slot, 13 coin slot, 14 money amount display, 15 coin return slot, 16 product selection operating unit, 17 product takeout port, 18 product cabinet, 20, 201, 202 product storage device, 21 bottom, 22 side plate, 23 spiral member, 24 holding member, 25 driving mechanism, 30 product bucket, 40 bucket movement mechanism, 231 first spiral member, 232 second spiral member, 241 first holding member, 241A engagement portion, 241B side surface, 241C non-engagement portion, 242 second holding member, 242A engagement portion, 242B side surface, 242C non-engagement portion, 2401 through-hole, 2401a first square hole, 2401b second square hole, 2402 first spiral holding portion, 2403 locking portion, 2403a base, 2403b bending portion, 2403c locking tip, 2404 outer circumference, 2433 groove, 2433a locked groove, 2433b inner wall, 2434 second spiral holding portion, 2435 protrusion, 2435a claw, 34, 36 axial position holding member, 341, 361 first axis holding member, 3411 first rotating plate, 3412 first attachment, 3413 first pushing piece, 3414 coupling protrusion, 3414a first coupling protrusion, 3414b second coupling protrusion, 3414a-1 first hook claw, 3414b-1 second hook claw, 342 362 second axis holding member, 3421 second rotating plate, 3422 second attachment, 3423 second pushing piece, 3424 coupling hole, 343 coupling portion #

1. A product storage device for a vending machine, comprising:
a spiral member formed in a spiral and configured to store a product in a gap formed by the spiral;
a holding member configured to hold one end of a rotation axis direction of the spiral member; and
a driving mechanism configured to rotate the spiral member by rotating the holding member, wherein:
the spiral member is rotated around a rotation axis based on driving of the driving mechanism to move the product stored in the gap in the rotation axis direction;
the spiral member includes a first spiral member and a second spiral member which have the same rotation axis and the gap of the same length; and
a position of the first spiral member relative to the second spiral member in a rotating direction is changed to change the length of the gap formed by the first spiral member and the second spiral member.

2. The product storage device for a vending machine according to claim 1, wherein a spiral diameter of the second spiral member is greater than that of the first spiral member.

3. The product storage device for a vending machine according to claim 1, wherein:
the holding member includes a first holding member configured to hold one end of the first spiral member, and a second holding member configured to hold one end of the second spiral member, the second holding member being able to engage with the first holding member; and
one of the first holding member and the second holding member is rotated with respect to the other to form gaps each having a length corresponding to a rotation angle for the rotation of one of the first holding member and the second holding member with respect to the other.

4. The product storage device for a vending machine according to claim 3, wherein:
the first holding member includes locking portions at a plurality rotation angle positions for the rotation with respect to the second holding member;
the second holding member includes locked portions in which the locking portions are locked; and
the locking portions are locked in the locked portions to restrict the first holding member from rotating in a direction opposite to the direction in which the first holding member is rotated with respect to the second holding member.

5. The product storage device for a vending machine according to claim 1, further comprising an axial position holding member,
the axial position holding member including:
a first axis holding member attached to the other end of a rotation axis direction of the first spiral member held by the holding member; and
a second axis holding member attached to the other end of a rotation axis direction of the second spiral member held by the holding member,
the axial position holding member being formed by rotatably coupling the first axis holding member and the second axis holding member to one another,
wherein, while the first axis holding member is attached to the other end of the rotation axis direction of the first spiral member and the second axis holding member is attached to the other end of the rotation axis direction of the second spiral member, the axial position holding member aligns a rotation axis of the first spiral member with a rotation axis of the second spiral member.

6. The product storage device for a vending machine according to claim 5, wherein at least one of the first axis holding member and the second axis holding member includes a pushing piece projecting from the spiral member in a moving direction of the product.
